(19) United States
(12) Patent Application Publication
(10) Pub. No.: US 2005/0103950 A1
(43) Pub. Date: May 19, 2005

(54) Collapsible refuse bag holder

(76) Inventor: Roland Joubert, Warminster, PA (US)

Correspondence Address: GREGORY J. GORE, 70 WEST OAKLAND AVENUE, SUITE 316, DOYLESTOWN, PA, 18901, US

(21) Appl. No.: 10/705,842

(22) Filed: Nov. 13, 2003

(51) Int. Cl. B62B 1/00

(52) U.S. Cl. 248/98; 248/129; 280/47.17

(57) ABSTRACT

A refuse bag cart is fully collapsible and includes novel means for supporting the mouth of the refuse bag in its fully opened position. Individual rotatable support arms each include novel clamp means which firmly grip opposite sidewalls of the mouth of the refuse bag at the top. The length of each support arm is sized to the bag dimension to provide sidewall support as well as a laterally movable structure to hold the mouth of the bag open. The support arms are rotatable in the horizontal plane so that bags of different circumference may be held fully open. The support arms are further pivotable in the vertical plane. Because the support arms occupy the interior of the bag in their operative position, the vertical pivot allows them to be swung downward into the bag cavity easily and quickly. Over-the-center, locking toggle clamp means are included on each support arm and each clamp has elongate jaws which firmly grip sidewalls of the bag and lock in the closed position.

### FIELD OF THE INVENTION

This invention relates to a collapsible refuse bag holder for household and lawn use. More specifically, the invention is a wheeled bag cart which is collapsible and particularly suited for large refuse bags such as lawn leaf bags.

### BACKGROUND OF THE INVENTION

Transportable holders for household refuse bags which provide for the convenient transportation of trash bags are well known, particularly for lawn and garden use. These devices are typically wheeled and have means for supporting the refuse bag, which is usually made of paper, holding it upright and with its mouth open. Even though bags of this type are designed to be somewhat self-supporting because they are extremely lightweight and made of paper they can blow over and be difficult to handle. Therefore, various of these devices to support the bag in its open condition and to securely transport it from one location to another have been devised.

An example of a transportable bag cart of the above-described type is shown in U.S. Pat. No. 5,947,492 issued to Hallberg, Jr. entitled “Transportable Bag Cart.” Other pertinent patent prior art of which the applicant is aware includes U.S. Patent Publication 2002/0104932 published by Johnston entitled “Holder for Refuse Bags”; U.S. Pat. No. 5,069,405 issued to Keating entitled “Mobile Leaf Bag Loading Fixture”; and U.S. Pat. No. 4,160,557 issued to Taylor entitled “Collapsible Refuse Bag Cart.” While these prior art devices generally seek to make more convenient the use and portability of lawn and garden refuse bags, they suffer from the shortcoming of not conveniently holding the mouth of the refuse bag reliably and firmly in the open position. They are also often awkward and difficult to operate.

### SUMMARY OF THE INVENTION

In order to solve the problems in the prior art, the applicant has invented a wheeled refuse bag cart of superior design and construction. The present refuse bag cart is fully collapsible and includes novel means for supporting the mouth of the refuse bag in its fully opened position. Individual rotatable support arms each include novel clamp means which firmly grip opposite sidewalls of the mouth of the refuse bag at the top. The length of each support arm is sized to the bag dimension to provide sidewall support as well as a laterally movable structure to hold the mouth of the bag open. The support arms are rotatable in the horizontal plane so that bags of different circumference may be held fully open. The support arms are further pivotable in the vertical plane. Because the support arms occupy the interior of the bag in their operative position, the vertical pivot allows them to be swung downward into the bag cavity easily and quickly. Over-the-center, locking toggle clamp means are included on each support arm and each clamp has elongate jaws which firmly grip sidewalls of the bag and lock in the closed position. It will be understood by those of skill in the art that by these mechanical relations refuse bags are fully supported both laterally and vertically.

More specifically, the applicant has invented a holder for refuse bags comprising a substantially vertical planar back frame with a handle at the top and further including left and right side frame members. Means at the bottom of the back frame support a laterally extending axle which carries a wheel at each of its opposite ends. A substantially horizontal base frame is rotatably supported by the axle and the side frame members. Two frontally-extending elongate support arms are affixed to the side frame members at the top, each support arm being individually pivotable laterally and vertically, with respect to the side frame member of the back frame to which it is affixed. Bag clamps are carried on each support arm. Each clamp includes one jaw rigidly affixed to the support arm and a second movable jaw pivotably supported by the support arm. The support arms are affixed to the side frame members by screw clamps that are vertically adjustable along the side frame members. Hinged strut means support the base frame and are connected between the front of the base frame and the side frame members. The base frame is rotatably affixed to the axle so that it can be folded upwardly from a substantially horizontal position to a substantially vertical position adjacent the back frame. The back frame includes a catch for releasably securing the base frame in its folded condition. Each of the bag clamps includes a toggle linkage which permits each pair of jaws to be locked in the clamped position. The jaws further include a resiliently compressible component so that the bag is resiliently gripped in compression when clamped. With the refuse bag installed, the upper edge of the bag is secured between the jaws of the clamp means at each sidewall of the bag, the sidewall dimension being approximately the same length as each support arm. When the bag is clamped in position, the movable jaw lies within the refuse bag and also extends substantially the entire length of the bag sidewall.

It is therefore an object of the present invention to provide a transportable refuse bag cart which is convenient and easy to use. It is a further object of the present invention to provide a transportable refuse bag cart which firmly and reliably retains the refuse bag in proper orientation with the mouth of the bag held firmly and fully open. It is another object of the present invention to provide a transportable refuse bag cart which is economical to manufacture and collapsible for easy storage. It is yet a further object of the invention to provide a refuse bag cart with the ability to accommodate different size bags. Further objects and advantages of the invention will be apparent to those of skill in the art from the following drawings and description of the preferred embodiment.

### BRIEF DESCRIPTION OF THE DRAWINGS

FIG. 1 is a top left front isometric view of the present invention with an installed refuse bag shown in partial cut-away view.

FIG. 2 is a right side elevation view of the invention.

FIG. 3 is a partial side view of the collapsible base and slide lock mechanism with alternate positions of these structures shown in phantom.

FIG. 4 is a right side view of the left support arm.

FIGS. 5 and 6 are rearward elevation sectional views of the right side support arm clamp mechanism taken from FIG. 4 in the open and locked positions respectively.

### DESCRIPTION OF THE PREFERRED EMBODIMENT

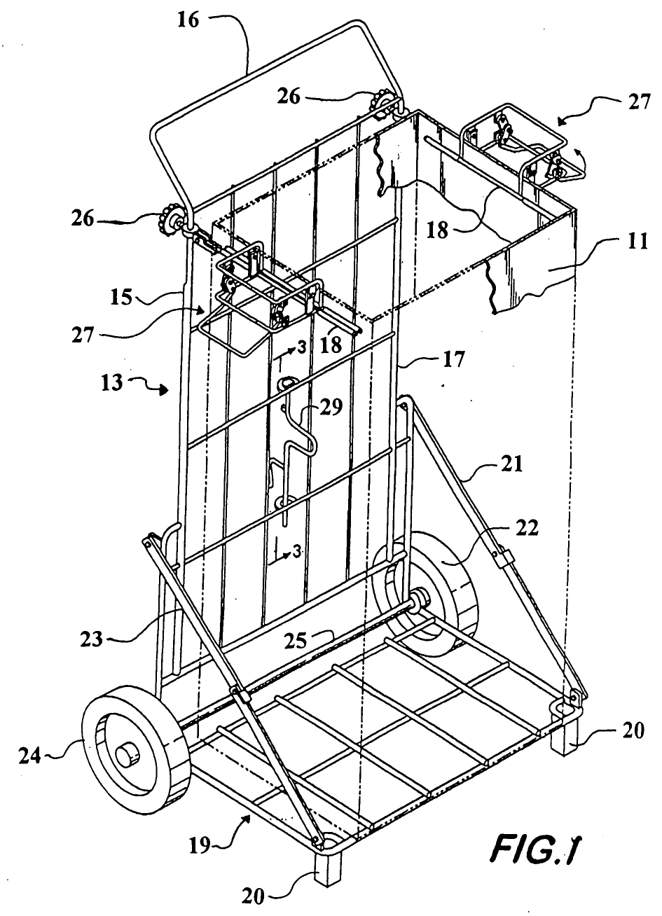

FIGS. 1-6 depict the preferred embodiment of the invention, the description of which follows. The device of the embodiment depicted is symmetrical having mirror image structures on right and left sides. It will therefore be understood that the description of structures on one side will be sufficient to fully describe those on the other side without requiring separate description. This applies for example to the support arms and refuse bag clamp means which are novel features of the invention. Also, it will be noted here that for better understanding like components are designated by like reference numbers throughout the various figures.

Referring now to FIG. 1, the refuse bag cart of the present invention includes a back frame 13 which includes right and left side frame members 15 and 17 that extend upwardly to a handle 16 that is angled backwardly at the top. The back frame carries a rigid axle 25 at the bottom. The axle supports wheels 22 and 24 at opposite sides thereof. Hinged struts 21 and 23 extend from the back frame to the front of a base frame 19 which provides horizontal support for a bag 11 installed on the cart. Feet 20 support the base frame from the ground holding the base frame in approximately a horizontal position while the back frame is supported in a substantially vertical position by struts 21 and 23. At the top of the back frame, two individually articulated support arms are slidably affixed proximate a top end thereof by clamp screws 26. Each support arm carries a clamp 27. Each clamp has elongate cylindrical jaws 18 which extend substantially the entire length of the sidewalls of bag 11. The back frame carries vertically slidable base frame catch 29.

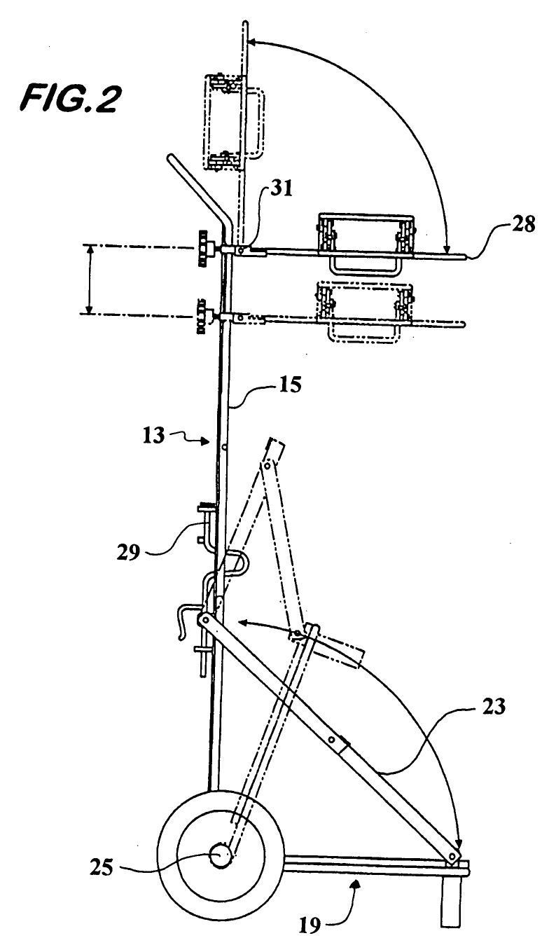

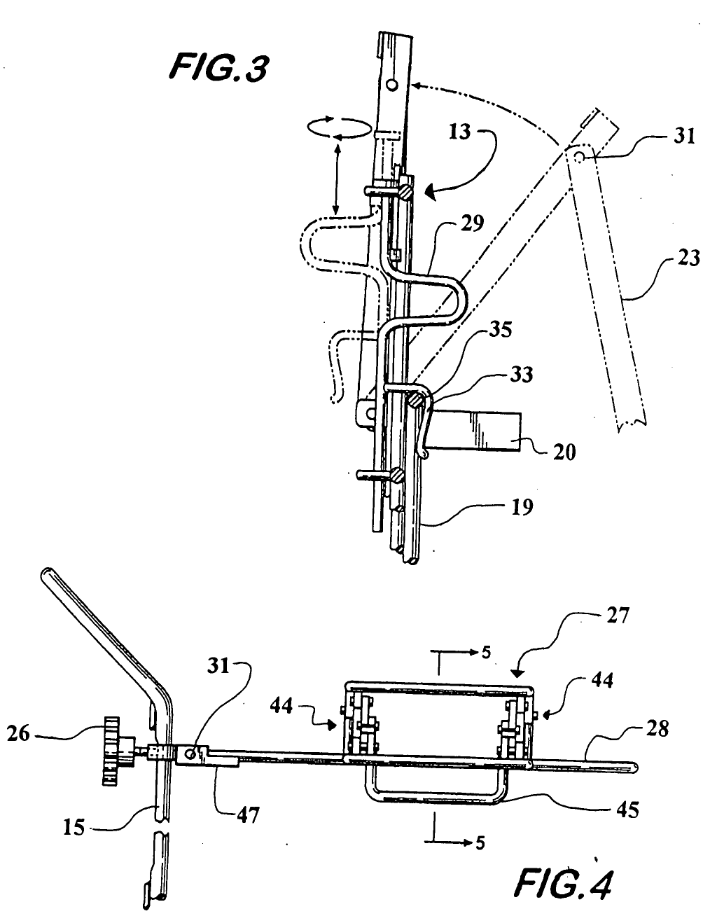

Referring now to FIG. 2, the details of the collapsibility of the present device are shown with alternate positions of the support arms and base frame shown in phantom. Each support arm 28 is suspended by a clamp screw from the top of a side member such as left side frame member 15 of the back frame 13. As shown in this figure, this permits support arm 28 to be vertically adjustable by simply loosening the clamp screw and sliding the support arm vertically between desired positions. The support arm further includes hinge joint 31 that allows it to swing upwardly in the vertical plane. Similarly, the base frame 19 may be folded upwardly for compact storage. This is achieved by its hinged attachment to axle 25 and hinged strut means 23 which permit the base frame to fold upwardly. The back frame further includes a catch 29 to secure the base frame that is shown in greater detail in FIG. 3.

Referring now to FIG. 3, greater detail of the foldable base frame 19 and catch 29 are shown. As the base frame is folded upward, strut 23 folds at hinge joint 31 until the base frame 19 is substantially vertical and resting against the back frame 13. Catch 29 is vertically slidable on back frame 13 and includes hook means 33 at the bottom. In operation, the catch is rotated 180 degrees and moved downward so that the hook engages the front frame member 35 of the base frame 19, retaining it against the back frame.

Referring now to FIG. 4, the right side support arm 28 is shown. Each support arm carries clamp means 27 that include toggle joints 44 at opposite sides and an actuation handle 45. As depicted in greater detail in FIG. 2, each support arm may be folded upward by means of hinge joint 31. Support arms are maintained substantially horizontal in their operative positions by stop 47. The support arm is slidably affixed to the side frame member 15 by a screw clamp 29 which includes a large thumb wheel for ease of manipulation without requiring a tool.

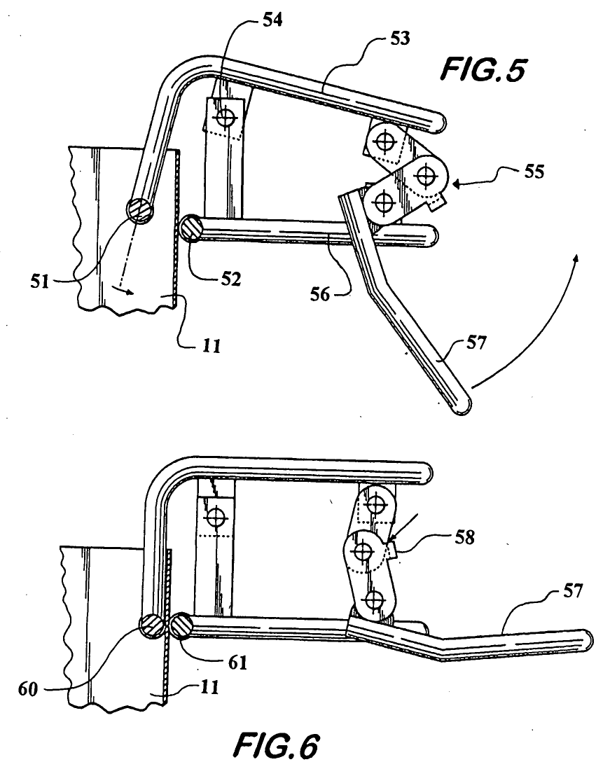

Referring now to FIGS. 5 and 6, the refuse bag clamp means is shown in its open and clamped positions respectively. Only the left side clamp mechanism of FIG. 4 is shown, it being understood that the description of these figures would apply equally to the right side clamp means which is substantially a mirror image thereof.

FIG. 5 depicts the clamp in the open position with jaws 51 and 52 positioned on opposite sides of the sidewall of bag 11. Jaw 52 is fixed to the framework of the cart being rigidly affixed to the support arm as shown in FIG. 4. Movable jaw 51 includes a curved extension 53 that pivots on fulcrum pin 54. Toggle linkage 55 is operative between pinned joints on jaw extensions 53 and 56. The toggle linkage is operative by handle 57. It will be understood by those of skill in the mechanical arts that when handle 57 is moved upwardly according to the arrow shown in FIG. 5 that the jaws are moved to their closed position clamping opposite sides of the bag sidewall as shown in FIG. 6.

Referring now to FIG. 6, clamp handle 57 is shown moved to its fullest extent being restricted over-center by stop 58 on the toggle linkage. Resilience of the components and the over-center condition of the toggle linkage restricted by stop 58 holds the jaws locked in their clamped position against the sidewall of bag 11. The jaws may further include resilient means 60 and 61 to provide greater friction grip of the bag sidewall and also to add resilience to the clamping mechanism so that the toggle linkage locking mechanism operates more easily. The resilient structures 60 and 61 may be simple elastomeric tubing placed over the elongate cylindrical jaws.

Referring again to FIG. 1, the device of the preferred embodiment is operated as follows. The refuse bag is first manually opened and placed on the base frame. With clamp jaws open, the support arms are swung downward from an upwardly retracted position so that the jaws are placed on opposite sides of the bag sidewalls. Each support arm can then be vertically adjusted so that the right and left side clamp jaws fall at the same height just below the upper edge of the refuse bag. The clamps are then actuated and locked in position clamping the bag sidewalls firmly. One or both of the support arms are then swung laterally outwardly to take up any dimensional slack of the bag width until the bag is taut across its front surface. The thumb wheels of the screw clamps of the support arms are then tightened in this position. The bag is now firmly supported and ready for use. After use, the bag may be removed by repeating the above-described operative steps in reverse order. With the bag removed, the refuse bag cart of the invention may be collapsed to its storage condition by folding the base frame upward and locking it in place and by retracting the support arms upwardly. Both of these operations are depicted in FIG. 2.

It will be appreciated in the foregoing description of the preferred embodiment and its operation that the objects of the invention have been achieved. It should be understood, however, that the scope and spirit of the invention are not limited to the preferred embodiment but are limited only by the scope of the following claims and their legal equivalents. For example, the preferred embodiment is shown constructed of welded heavy gauge wire, but any other suitable material may be used such as tubing. Furthermore, the material used need not be metal but may also be plastic.

1. A holder for refuse bags, comprising:
a substantially vertical planar back frame with a handle at the top and right and left side frame members;
means at the bottom of the back frame for supporting a laterally extending axle;
a substantially horizontal base frame supported by said axle and side frame members; and
two frontally-extending elongate support arms affixed to said side frame members proximate top ends thereof, each support arm being individually pivotable, laterally and vertically, with respect to the side frame member of said back frame to which it is affixed.

2. The refuse bag of claim 1 further including clamp means on each support arm, each clamp means including one jaw rigidly affixed to the support arm and a second movable jaw pivotably supported by said support arm.

3. The refuse bag holder of claim 1 further including a pair of wheels, each wheel supported at opposite ends of the axle.

4. The refuse bag holder of claim 1 wherein said support arms are affixed to said side frame members by screw clamps that are vertically adjustable along said side frame members.

5. The refuse bag holder of claim 3 further including hinged strut means connected between said base frame and said side frame members of said back frame.

6. The refuse bag holder of claim 4 wherein said base frame is rotatably affixed to said axle whereby said base frame can be folded upwardly from a substantially horizontal position to a substantially vertical position adjacent said back frame.

7. The refuse bag holder of claim 5 wherein said back frame includes a catch for releasably securing said base frame to said back frame in its folded condition.

8. The refuse bag holder of claim 7 wherein said clamp means includes a toggle linkage whereby said jaws may be locked in a clamped position.

9. The refuse bag holder of claim 8 wherein said jaws include a resiliently compressible component therebetween.

10. The refuse bag holder of claim 9 further including a refuse bag having a sidewall dimension approximately the same length as each support arm, said bag including an upper edge secured between said jaws of said clamp means when clamped.

11. The refuse bag holder of claim 10 further described in that said movable jaw lies within said refuse bag and extends substantially the entire length of the bag sidewall.
